(19) United States
(12) Patent Application Publication
(10) Pub. No.: US 2005/0207366 A1
(43) Pub. Date: Sep. 22, 2005

(54) METHOD OF SENDING A PAGING ANNOUNCEMENT OVER A ROAMING TELEPHONE NETWORK

(76) Inventor: Heng-Chien CHEN, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,621

(22) Filed: Mar. 16, 2004

(51) Int. Cl. H04Q 7/00

(52) U.S. Cl. 370/313; 370/401

(57) ABSTRACT

A method for sending a paging announcement to all telephones in a roaming telephone network. The roaming telephone network includes first and second local telephone groups each containing a plurality of telephones. The first and second local telephone groups are connected to the Internet through first and second dynamic IP addresses, respectively. A main host is connected to the Internet through a static IP address, and the main host controls voice packet traffic over the Internet between the first and second local telephone groups. The method includes using one telephone in the roaming telephone network to make a paging announcement, transmitting the paging announcement from the paging telephone to the main host, and transmitting the paging announcement from the main host to the first and second local telephone groups for broadcasting the paging announcement to the roaming telephone network.

### BACKGROUND OF INVENTION

1. Field of the Invention

The present invention relates to a telephone communication system, and more specifically, to a method of sending a paging announcement over a roaming telephone network created across the Internet by using dynamic Internet Protocol (IP) addresses.

2. Description of the Prior Art

The key telephone system (KTS) provides a simple and cost effective way for a small to medium sized business to provide telephone extensions for each of its employees.

The KTS structure allows a limited number of outside telephone lines connected to a public switched telephone network (PSTN) to be used by any of the phone extensions. In addition, KTS provides a very useful paging announcement function that allows a user to broadcast an announcement to all other KTS extensions. For example, a president of a company can use the paging announcement function to quickly inform all employees near their desks about important news. This paging announcement is immediately sent out, and gets the attention of employees much faster than other company-wide announcements made through other media such as email.

Unfortunately, the KTS network is a fixed structure, and cannot easily be expanded to include branch offices at other locations. Two branch offices at opposite ends of a country cannot easily be connected through a KTS network. Other telephone networks have been developed that allow remote locations to be connected together. For example, the Internet Protocol Private Branch exchange (IP PBX) and Voice Gateway systems both allow office branches separated by a large distance to be connected together through the Internet. However, neither of these systems allows users to send a system-wide paging announcement, as is possible in a KTS network.

### SUMMARY OF INVENTION

It is therefore an objective of the claimed invention to provide a method for sending a paging announcement to all telephones in a roaming telephone network in order to solve the above-mentioned problems.

According to the claimed invention, a method for sending a paging announcement to all telephones in a roaming telephone network is proposed. The roaming telephone network includes a first local telephone group and a second local telephone group each containing a plurality of telephones. The first and second local telephone groups are respectively connected to the Internet through first and second dynamic IP addresses, and each of the telephones in the first and second local telephone groups are assigned a unique identifier. A main host is connected to the Internet through a static IP address, and the main host controls voice packet traffic over the Internet between the first local telephone group and the second local telephone group. The method includes using one telephone in the roaming telephone network to make a paging announcement, transmitting the paging announcement from the paging telephone to the main host, and transmitting the paging announcement from the main host to the first and second local telephone groups for broadcasting the paging announcement to the roaming telephone network.

It is an advantage of the claimed invention that a system-wide paging announcement can be broadcast to all telephones that are connected to the roaming telephone network through the Internet. In addition, additional telephones can be connected to the roaming telephone network through a dynamic IP address, making it very easy to expand the roaming telephone network.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a roaming telephone network according to a first embodiment of the present invention.

FIG. 2 is a diagram of a roaming telephone network according to a second embodiment of the present invention.

FIG. 3 is a diagram of a roaming telephone network according to a third embodiment of the present invention.

### DETAILED DESCRIPTION

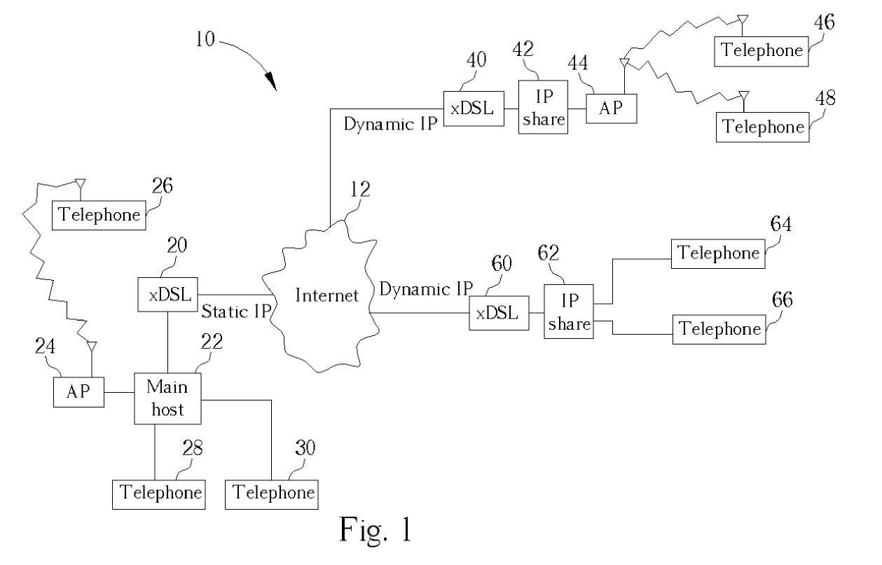

The present invention provides a roaming telephone network and a method of sending paging announcements to each telephone in the roaming telephone network. Please refer to FIG. 1. FIG. 1 is a diagram of a roaming telephone network 10 according to a first embodiment of the present invention. The roaming telephone network 10 allows telephone calls and paging announcements to be made over the Internet 12. A main host 22 of the roaming telephone network 10 connects to the Internet 12 through an Internet connection 20. The Internet connection 20 may be an xDSL connection or another suitable broadband Internet connection. The Internet connection 20 provides a static IP address to the main host 22, which ensures the main host 22 to always be located by other components in the roaming telephone network 10. An access point 24 is connected to the main host 22 for wirelessly connecting a telephone 26 to the main host 22. The telephone 26 can communicate with the access point 24 using at least one of the many IEEE 802.11x protocols. In addition, telephones 28 and 30 are directly connected to the main host 22. The telephones 28 and 30 can directly communicate with the main host 22 through a network cable according to the IEEE 802.3 protocol. The telephones 26, 28, and 30 make up a local telephone network since they are all located at the same geographical location.

Another local telephone network is connected to the roaming telephone network 10 through Internet connection 40. Unlike the Internet connection 20, the Internet connection 40 does not have to provide a static IP address, and a dynamic IP address can be used instead. An IP sharing device 42 is connected to the Internet connection 40, and is used to share the Internet connection 40 with each device connected to the IP sharing device 42. An access point 44 is connected to the IP sharing device 42 for wirelessly connecting telephones 46 and 48 to the roaming telephone network 10.

Likewise, another local telephone network is connected to the roaming telephone network 10 through Internet connection 60. The Internet connection 60 also provides a dynamic IP address. An IP sharing device 62 is connected to the Internet connection 60, and is used to connect telephones 64 and 66 to the roaming telephone network 10. Telephones 26, 28, and 30 are connected to the main host 22 locally, whereas telephones 46, 48, 64, and 66 are connected to the main host 22 remotely through the Internet 12. The roaming telephone network 10 is said to be roaming because telephones can easily be added to the roaming telephone network 10 through a dynamic IP address anywhere in the world.

Each of the telephones 26, 28, 30, 46, 48, 64, and 66 have a unique identifier. The main host 22 records the unique identifier for each of the telephones 26, 28, 30, 46, 48, 64, and 66 for identifying the telephones used in the roaming telephone network 10.

According to the first embodiment of the present invention, when one of the telephones in the roaming telephone network 10 sends out a paging announcement, the paging announcement is first sent to the main host 22.

The main host 22 then transmits the paging announcement to each of the other telephones in the roaming telephone network 10. Once the telephones receive the paging announcement from the main host 22, the telephones broadcast the received paging announcement. To illustrate this method for broadcasting the paging announcement to all telephones in the roaming telephone network 10, two examples will be given.

First, assume that the telephone 26 is used to make the paging announcement. When the user of the telephone 26 pushes the paging button on the telephone 26 and makes the paging announcement, the telephone 26 sends the paging announcement to the main host 22 via the access point 24. Then the main host 22 sends a copy of the paging announcement to each of the remaining telephones 28, 30, 46, 48, 64, and 66 in the roaming telephone network 10.

As a second example, suppose that the telephone 64 is used to make the paging announcement. When the user of the telephone 64 pushes the paging button on the telephone 64 and makes the paging announcement, the telephone 64 sends the paging announcement to the main host 22 via the Internet 12. The main host 22 then sends a copy of the paging announcement to each of the remaining telephones 26, 28, 30, 46, 48, and 66 in the roaming telephone network 10.

In the first embodiment of the present invention, the main host 22 sends a copy of the paging announcement to each individual telephone in the roaming telephone network 10 except for the telephone that made the paging announcement. As the number of telephones in the roaming telephone network 10 increases, the number of copies of the paging announcement that the main host 22 has to send out increases as well. Similarly, if one of the local telephone networks in the roaming telephone network 10 contains a vast number of telephones, the main host 22 will have to send a copy of the paging announcement to each of those telephones in the same local telephone network. For these situations, it may be advantageous to install a local host in each of the local telephone networks instead of relying only on the main host 22 to send out a copy of the paging announcement to each telephone in the roaming telephone network 10.

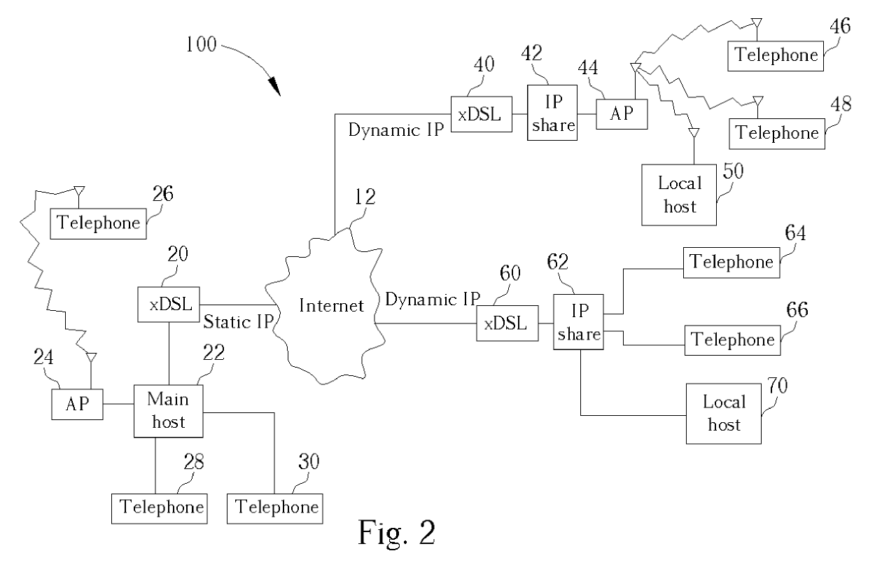

Please refer to FIG. 2. FIG. 2 is a diagram of a roaming telephone network 100 according to a second embodiment of the present invention. In the roaming telephone network 100, a local host 50 is added to the local telephone network connected to the roaming telephone network 100 through the Internet connection 40. Likewise, a local host 70 is added to the local telephone network connected to the roaming telephone network 100 through the Internet connection 60. Instead of sending a copy of the paging announcement to each individual telephone in remote telephone networks, the main host 22 instead only needs to send one copy to each of the local hosts 50 and 70. Thus, the topology of the roaming telephone network 100 using the local hosts 50 and 70 can drastically reduce the number of copies of the paging announcement that the main host 22 needs to send out over the Internet 12. To better illustrate the method in which the roaming telephone network 100 operates, the same two examples given above will be repeated with the relevant portions changed.

As a first example, assume that the telephone 26 is used to make the paging announcement. When the user of the telephone 26 pushes the paging button on the telephone 26 and makes the paging announcement, the telephone 26 sends the paging announcement to the main host 22 via the access point 24. Then the main host 22 sends a copy of the paging announcement to each of the telephones 28 and 30 in the same local telephone network as the main host 22. At the same time, the main host 22 sends a copy of the paging announcement to each of the local hosts 50 and 70. The local host 50 sends a copy of the paging announcement to each of the telephones 46 and 48 via the access point 44. The local host 70 also sends a copy of the paging announcement to each of the telephones 64 and 66 through the IP sharing device 62.

As a second example, suppose that the telephone 64 is used to make the paging announcement. When the user of the telephone 64 pushes the paging button on the telephone 64 and makes the paging announcement, the telephone 64 sends the paging announcement to the main host 22 via the Internet 12. The main host 22 then sends a copy of the paging announcement to each of the telephones 26, 28, and 30 in the same local telephone network as the main host 22. At the same time, the main host 22 sends a copy of the paging announcement to each of the local hosts 50 and 70. The local host 50 sends a copy of the paging announcement to each of the telephones 46 and 48 through the access point 44, and the local host 70 sends a copy of the paging announcement to the telephone 66 through the IP sharing device 62.

With topology of the roaming telephone network 100 according to the second embodiment of the present invention, the local hosts 50 and 70 send copies of the paging announcement to each telephone in their respective local telephone networks. Therefore, the main host 22 only needs to send a copy of the paging announcement to each local host 50 and 70 in the roaming telephone network 100 instead of sending a copy of the paging announcement to each telephone in the roaming telephone network 100.

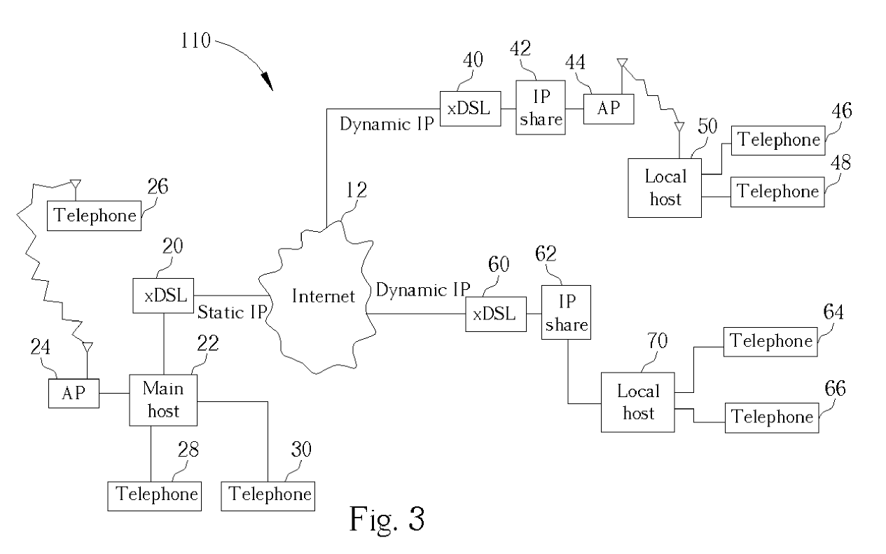

Please refer to FIG. 3. FIG. 3 is a diagram of a roaming telephone network 110 according to a third embodiment of the present invention. The roaming telephone network 110 of FIG. 3 is very similar to the roaming telephone network 100 of FIG. 2 except for the way in which telephones are connected to the local hosts 50 and 70. As shown in FIG. 3, the telephones 46 and 48 are each directly connected to the local host 50, and the telephones 64 and 66 are each directly connected to the local host 70. When the local host 50 sends a copy of the paging announcement to the telephones 46 and 48, the local host 50 sends the copy of the paging announcement directly to each of the telephones 46 and 48 instead of sending it through the access point 44, as was done in the roaming telephone network 100 of FIG. 2. In the same way, the local host 70 sends the copy of the paging announcement directly to each of the telephones 64 and 66 since the telephones 64 and 66 are directly connected to the local host 70. Other than this, the operation of the roaming telephone network 110 is the same as the roaming telephone network 100 of the second embodiment of the present invention.

In summary, the present invention roaming telephone network is offers the ability to broadcast paging announcements throughout the entire roaming telephone network. If one of the telephones in the roaming telephone network is used to make a paging announcement, the roaming telephone network will broadcast the paging announcement on all other telephones in the roaming telephone network. The roaming telephone network is not restricted to a small geographical location as is the KTS network of the prior art. Therefore, additional telephones can be connected to the roaming telephone network through a dynamic IP address, making it very easy to expand the roaming telephone network.

Those skilled in the art will readily observe that numerous modifications and alterations of the device may be made while retaining the teachings of the invention. Accordingly, the above disclosure should be construed as limited only by the metes and bounds of the appended claims.

1. A method for sending a paging announcement to all telephones in a roaming telephone network, the roaming telephone network comprising:
a first local telephone group and a second local telephone group each containing a plurality of telephones, the first and second local telephone groups being respectively connected to the Internet through first and second dynamic IP addresses, and each of the telephones in the first and second local telephone groups being assigned a unique identifier; and
a main host connected to the Internet through a static IP address, the main host capable of controlling voice packet traffic over the Internet between the first local telephone group and the second local telephone group; the method comprising:
using one telephone in the roaming telephone network to make a paging announcement;
transmitting the paging announcement from the paging telephone to the main host; and
transmitting the paging announcement from the main host to the first and second local telephone groups for broadcasting the paging announcement to the roaming telephone network.

2. The method of claim 1 wherein the main host transmits the paging announcement to all telephones in the roaming telephone network through the Internet.

3. The method of claim 1 wherein the first and second local telephone groups respectively comprise a first local host and a second local host for receiving the paging announcement from the main host and for respectively transmitting the paging announcement to each telephone in the first and second local telephone groups.

4. The method of claim 3 wherein all telephones in the first local telephone group and all telephones in the second local telephone group are directly connected to the first and second local hosts, respectively, and the first and second local hosts directly transmit the paging announcement to each telephone in the first and second local telephone groups, respectively.

5. The method of claim 3 wherein all telephones in the first local telephone group and all telephones in the second local telephone group are respectively connected to the first and second local hosts through local networks, and the first and second local hosts respectively transmit the paging announcement to each telephone in the first and second local telephone groups through the local networks.

6. The method of claim 1 wherein the roaming telephone network further comprises a third local telephone group containing a plurality of telephones directly connected to the main host, and the main host directly transmits the paging announcement to each telephone in the third local telephone group.

7. The method of claim 1 wherein each of the telephones in the first and second local telephone groups are respectively connected to the Internet through first and second IP sharing devices.

8. The method of claim 7 wherein the telephones in the first and second local telephone groups are respectively connected to the first and second IP sharing devices through a network cable according to the IEEE 802.3 protocol.

9. The method of claim 7 wherein the telephones in the first and second local telephone groups are wirelessly connected to the first and second IP sharing devices ac- cording to an IEEE 802.11x protocol, respectively.
